(19) United States
(12) Patent Application Publication
(10) Pub. No.: US 2019/0135419 A1
(43) Pub. Date: May 9, 2019

(54) FOLDABLE UNMANED AERIAL VEHICLE (UAV)

(71) Applicant: Vantage Robotics LLC, San Leandro, CA (US)

(72) Inventors: Tobin Joseph Fisher, San Francisco, CA (US); Johannes van Niekerk, Livermore, CA (US); Noah Gennaro Shartle, Oakland, CA (US); Aaron Robinson Breen, Oakland, CA (US)

(73) Assignee: Vantage Robotics LLC, San Leandro, CA (US)

(21) Appl. No.: 16/179,602

(22) Filed: Nov. 2, 2018

Related U.S. Application Data
(60) Provisional application No. 62/581,616, filed on Nov. 3, 2017.

(51) Int. Cl. B64C 27/00; B64C 39/02; B64C 27/473

(52) U.S. Cl. CPC B64C 27/006; B64C 39/024; B64C 2027/4736; B64C 2201/027; B64C 2201/108; B64C 27/473

(57) ABSTRACT

An Unmanned Aerial Vehicle (UAV) having foldable arms is disclosed. The UAV comprises a main body housing an electrical circuitry and a payload, such as a camera. A set of arms are connected to the main body. The arms connected to the main body of the UAV comprise propellers connected to each of the arms. The arms connected to the main body of the UAV comprise of an impact protection mechanism. The impact protection mechanism allows an omni-directional movement of each of the arms. Therefore, the UAV gets protected using such design, and damage to the UAV and individuals present around is significantly reduced.

### CROSS-REFERENCE TO RELATED APPLICATIONS

The present application is related to and claims priority of U.S. provisional patent application titled “A foldable Unmanned Aerial Vehicle (UAV)”, Ser. No. 62/581,616, filed on Nov. 3, 2017, the description of the same is incorporated herein in its entirety.

### FIELD OF THE DISCLOSURE

The present disclosure is generally related to an Unmanned Aerial Vehicle (UAV), and more particularly to a foldable design of the UAV.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also correspond to implementations of the claimed technology.

Unmanned Aerial Vehicles (UAVs) such as flying robots, drones, airplanes, helicopters, and multi-copters have found widespread usage for different purposes. For example, the UAVs are used in security, surveillance, search and rescue, and photography and leisure environments, such as theme parks, film sets, sports environments, and news environments. A pilot can wirelessly navigate a UAV from a remote location. Alternatively, the UAV may have an autopilot feature so that it is automatically operated and navigated by a computing device without human control.

In several conditions, the UAVs may collide with objects or may fall upon the ground. Such events may result into a partial or total damage of the UAVs. For example, propeller's impact with a foreign object may result in shearing of blades or damage to the propeller. The impact may affect structural integrity of the propeller and the UAV. The unprotected spinning blades pose a tremendous risk with the potential of inflicting damage to the craft itself and individuals and property present around the UAV. Additionally, the kinetic energy of the overall craft either in flight or free fall also poses a risk to both people and property.

Several attempts have been made in the past to protect the blades by enclosing them in rigid frame structures, which either partially surround or fully encircle the propellers. These structures typically flex and deform during impact and cause damage to the craft and the propellers. The rigid frame structures tend to be heavy, fragile, large, and can create excessive wind drag, or creating unwanted turbulence around the spinning propeller, which reduces performance and efficiency. Additionally, blade designs have been proposed which use elastomeric leading edges and tips to reduce risk, but these designs suffer from deformation of the elastomeric material at the tip of the blade, resulting in substantially reduced performance. Thus, a novel mechanism is needed to prevent injury to individuals, damage to property, and the UAV, during impacts.

### BRIEF DESCRIPTION OF THE EXEMPLARY EMBODIMENTS

A foldable Unmanned Aerial Vehicle (UAV) is described herein. The UAV includes a main body comprising at least electrical circuitry, a battery, and at least one sensor. The UAV further includes a plurality of arms connected to the body, and a motor and propeller connected to each arm of the plurality of arms. Each arm may be connected to the main body using an impact protection mechanism. The impact protection mechanism helps in maintaining a rigid connection until a maximum load force from a given direction is exceeded. During such conditions, the impact protection mechanism allows for an omni-directional movement of the plurality of arms. This maximum load force may be exceeded either by direct impact to an object or person, impact of the body of the UAV with an object or person, or impact of the propeller of the UAV with an object or person. In each case, the deformation of the plurality of arms allow for reduced peak impact forces, pressures, specific energies, and total energies.

The main body may comprise sensors such as magnetometer, accelerometer, gyroscope, Global Positioning System (GPS), sonar, contact sensor, and electrical contact based sensor. One of the sensors may detect movement of an arm beyond a pre-defined threshold, indicating that the arm is no longer rigidly coupled to the main body. When the sensor detects that the arm is no longer rigidly coupled to the body, the sensor may disconnect or actively stop the motor and propeller, through a microcontroller, activated response to the motor controllers or an electrical circuit that interrupts the supply of electricity to the motor driving the propeller on said arm.

Another embodiment involves the impact protection mechanism utilizing one of a pair of magnets, a spring, and a mechanical joint. While the pair of magnets is utilized, a first magnet may be present on an arm and a second magnet may be present on a hub connected to the main body. The spring may be connected inside of an arm and extending to the main body. The mechanical joint, when utilized, may connect the plurality of arms with the main body.

A further embodiment includes the propeller comprising at least one blade in which materials or structures of different hardness are used such that lower hardness materials are used in regions of the blade most likely to cause injury or damage in impact. An inner section of a blade may be made of a first material and an outer section of the blade may be made of a second material. The inner section and the outer section may be adjoined using adhesives, overmolding, barbed structures, or press fits. The first material may be plastic, carbon composite, wood, or metal. The second material may be expanded polystyrene foam, extruded polypropylene foam, expanded polypropylene foam, other foamed plastics, low-density woods, including balsa wood, resin mixed with hollow microspheres, and elastomeric materials. The second material may be covered with layers made of skinned foam or a tape embedded with a stiff tensile element. The stiff tensile element may be fiberglass, carbon, vacuum formed plastic, blow molded covering, and resin covering.

### BRIEF DESCRIPTION OF THE DRAWINGS

The accompanying drawings illustrate various embodiments of systems, methods, and embodiments of various other aspects of the disclosure. Any person with ordinary skills in the art will appreciate that the illustrated element boundaries (e.g. boxes, groups of boxes, or other shapes) in the figures represent one example of the boundaries. It may be that in some examples one element may be designed as multiple elements or that multiple elements may be designed as one element. In some examples, an element shown as an internal component of one element may be implemented as an external component in another, and vice versa. Furthermore, elements may not be drawn to scale. Non-limiting and non-exhaustive descriptions are described with reference to the following drawings. The components in the figures are not necessarily to scale, emphasis instead being placed upon illustrating principles.

FIG. 1 illustrates an exploded view of an unmanned Aerial Vehicle (UAV) 102, according to an embodiment.

FIG. 2 illustrates a blade 204 of a propeller attached to arms of a UAV 102, according to an embodiment.

FIG. 3 illustrates a barbed press fit joint 302 used for joining an inner section 206 and an outer section 208 of a blade 204, according to an embodiment.

FIG. 4 illustrates a cross-sectional view of a leading edge 402 of a blade 204 made of an elastomeric foam or other deformable material, according to an embodiment.

FIG. 5a and FIG. 5b illustrate an edge 502 of blade 204 made of an elastomeric material and a rest portion 504 of the blade 204 made of a stiff polymer, according to an embodiment.

FIG. 6 illustrates a blade 602, made of a deformable material, such as foam, balsa, wood, or soft plastic, on the outer section extending to the inner section 606. The inner section 606 of the blade 602 comprising a skeleton structure 608, according to an embodiment.

FIG. 7 illustrates a carbon fiber propeller 702 fabricated out of woven sheet carbon fiber with a co-molded leading edge, according to an embodiment.

FIG. 8 illustrates an exploded view of the carbon fiber propeller 702 with a co-molded elastomeric leading edge, according to an embodiment.

FIG. 9 illustrates a simplified top view of a two-part mold 902 for fabricating the carbon fiber propeller 702, according to an embodiment.

FIG. 10 illustrates a simplified top view of a two-part mold 1002 for co-molding a leading edge with an air foil cross-section onto the carbon fiber propeller 702, according to an embodiment.

FIGS. 11a and 11b illustrate a cross-section view of the carbon fiber propeller 702 with an elastomeric co-molded elastomer edge portion 708 having an air-foil shape, according to an embodiment.

FIG. 12 illustrates a tapered torsion resisting feature and semi-flexible rod to maintain orientation of the arm.

The headings used herein are for organizational purposes only and are not meant to limit the scope of the description or the claims. To facilitate understanding, reference numerals have been used, where possible, to designate like elements common to the figures.

### DETAILED DESCRIPTION

Some embodiments of this disclosure, illustrating all its features, will now be discussed in detail. The words “comprising,” “having,” “containing,” and “including,” and other forms thereof, are intended to be equivalent in meaning and be open ended in that an item or items following any one of these words is not meant to be an exhaustive listing of such item or items, or meant to be limited to only the listed item or items.

It must also be noted that as used herein and in the appended claims, the singular forms “a,” “an,” and “the” include plural references unless the context clearly dictates otherwise. Although any systems and methods similar or equivalent to those described herein can be used in the practice or testing of embodiments of the present disclosure, the preferred, systems and methods are now described.

Embodiments of the present disclosure will be described more fully hereinafter with reference to the accompanying drawings in which like numerals represent like elements throughout the several figures, and in which example embodiments are shown. Embodiments of the claims may, however, be embodied in many different forms and should not be construed as limited to the embodiments set forth herein. The examples set forth herein are non-limiting examples and are merely examples among other possible examples.

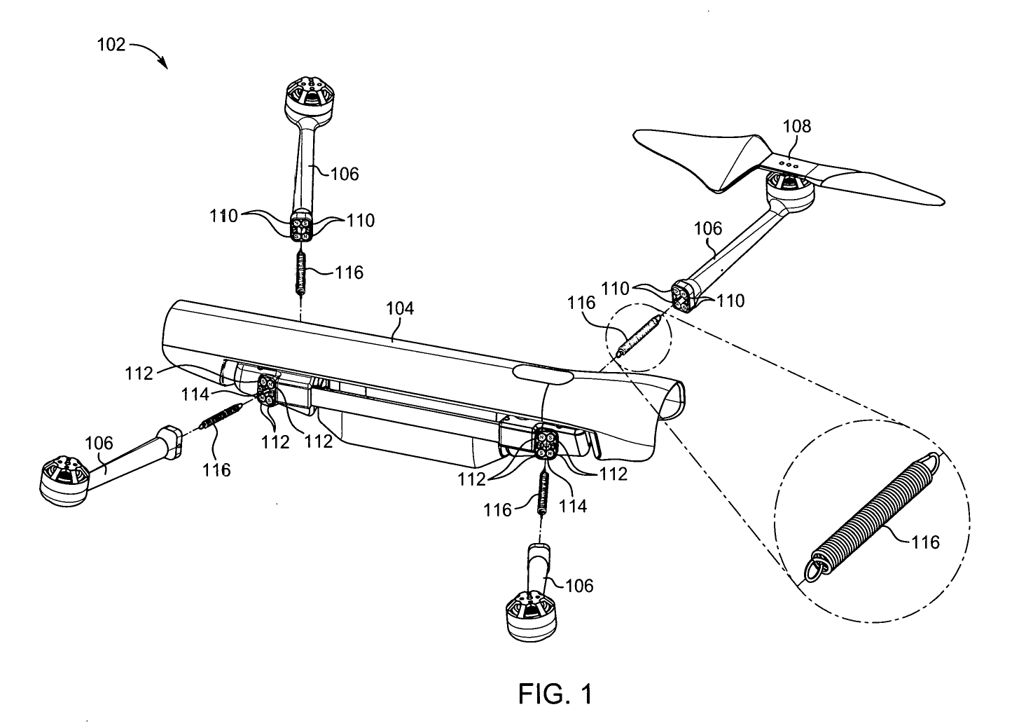

FIG. 1 illustrates an exploded view of an Unmanned Aerial Vehicle (UAV) 102. The UAV 102 comprises a main body 104, arms 106, and a propeller 108. Although the propeller 108 is illustrated to be present on a single arm for simplicity, but the propeller 108 may be present on each of the arms 106. The main body 104 may comprise electrical circuitry and sensors, including a camera. The electrical circuitry may comprise electronic control units for the functioning of propeller motor, motor drivers for speed variation function of the propeller, electrical wires connecting the propeller motor to electronic components, and sensors required for operation of the UAV 102. In one case, the sensors may comprise magnetometer, accelerometer, barometer, gyroscope, Global Positioning System (GPS), sonar, contact sensors, and numerous others.

The camera may be used for capturing images or video. The images or video may be used for surveillance purpose, search and rescue operations, inspection purposes, and aerial photography.

In one embodiment, the arms may be connected to the body using an impact protection mechanism. The impact protection mechanism may help the arms to fold off in a variety of directions during an impact. In one embodiment, the impact protection mechanism may comprise magnets. Amongst a pair of magnets, a first magnet 110 may be present on the arm and a second magnet 112 may be present on a hub 114 connected to the main body 104, as illustrated in FIG. 1. Each arm containing the first magnet 110 may connect to the hub 114 present on respective sides of the main body 104.

In one embodiment, pairs of magnets may be arranged in a manner that opposite poles may interact upon connection of the two or more pairs of magnets. The magnets are arranged in a manner having the north and south poles of the magnets are present adjacent to each other, in order to maximize attractive magnetic forces. Such arrangement of magnets closes a magnetic circuit, which also reduces stray magnetic fields. A material of high permissivity may also be arranged on the ends of the magnets to further close the magnetic circuit, both minimizing the stray field and increasing the pull force. Further, multiple pairs of magnets may be used for providing increased strength. In one case, the magnets may be used in a closed pattern, such as a circular pattern, square pattern, or rectangular pattern to counter multiple forces experienced by the arm during flight. The magnet arrangement in a closed pattern also increases the break-away force. In one case, larger magnets may be used on the lower half of the joint to provide additional strength for forces in the upward direction on the end of the arm, based on expected forces from the propellers.

In one embodiment, the impact protection mechanism may be implemented using a spring 116, as illustrated in FIG. 1. The spring 116 may be arranged inside the arm extending to the main body 104 of the UAV 102. The spring 116 may be arranged in a manner that may allow the arms to retract back to its original position following an impact. Further, the spring 116 may increase the breakaway forces experienced by the UAV 102 during impact reducing the total force needed from the magnets for a given target breakaway moment. The spring 116 may also enclose the wires connecting to the motors on the arms. The spring 116 may act as a protective covering over the electrical circuitry elements and protect them from damage. Various types of springs, such as coil springs, elastomeric tubes, leaf springs, and the like may be used.

In another embodiment, the impact protection mechanism may be implemented using a mechanical joint. The mechanical joint may be arranged on the arms extending to the main body. The mechanical joint may be arranged in a manner that allows the arms 106 to retract back to its original position after an impact. The mechanical joint may comprise of various types of joints, such as snap fit joints, two-way hinges, and the like. In one case, preload spring may be used to increase breakaway force and cause the arms to return to their correct position after impact or storage.

In another embodiment, the UAV 102 may fold for portability and utilize an enclosure to hold the arms in the open position. This enclosure can also act as a protective casing. The impact protection mechanism may allow for a compact packaging of the UAV 102 inside the enclosure. The mechanism described for impact protection may also help in rapid deployment of the UAV 102. The arms 106 may return to their original position upon removal from the protective casing.

In another embodiment, a cord or an extension limiter may be used to limit the movement of the arms and prevent over-travel during an impact. The cord or extension limiters may help in resisting the movement of the arms 106, and hence protect electrical wiring and other components from damage during the impact or folding for storage.

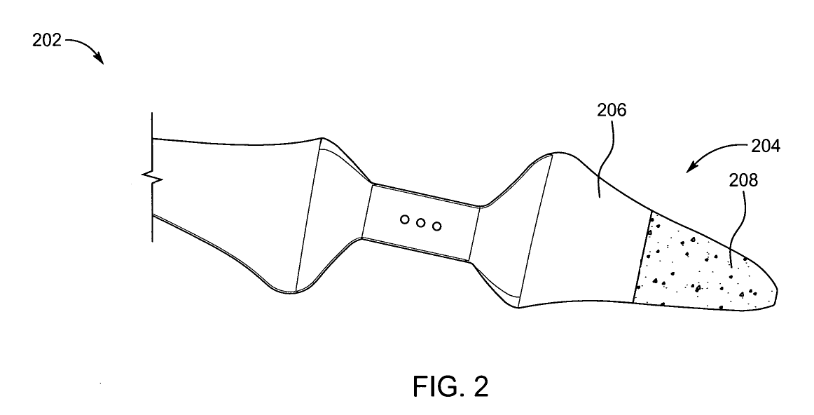

FIG. 2 illustrates a blade of a propeller 202 attached to the arms. The blade 204 may be constructed in such a manner that the blade 204 is divided into an inner section 206 and an outer section 208. In one embodiment, the inner section 206 of the blade 204 may be constructed using a stiff material. The stiff material may comprise, but is not limited to plastic, carbon composite, and metals. The stiff material on the inner section 206 of the blade 204 may help in retaining the structural integrity of the propeller 202 in flight.

In one embodiment, the outer section of the blade 204 may be constructed using a lightweight low density material. Such material may comprise, but is not limited to, expanded polystyrene foam, extruded polypropylene foam, expanded polypropylene foam, and elastomeric materials. The outer section 208 of the blade made of lightweight low density material may be covered with layers to increase its stiffness and flexibility. The covering layer may be made of skinned foam, a tape with stiff tensile element embedded in the tape like fiberglass, carbon, vacuum formed plastic, blow molded covering, resin covering, and the like. In one case, vacuum formed plastic bonded to top and/or bottom surface of foam to increase stiffness of blades.

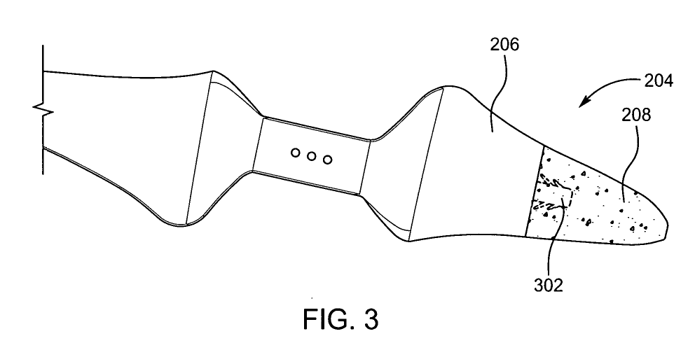

In one embodiment, the inner section 206 and the outer section 208 of the blade 204 may be coupled together using mechanical joints, such as lap joint, butt joint, pinned joint, and sockets, such as plastic outer socket and foam inside socket. Further adhesion techniques, such as double-sided tape, adhesive, and press fit, barb, snap fit, and over molded design may be used. For example, a barbed press fit joint 302 may be used to join the inner section 206 and the outer section 208 of the blade 204, as illustrated in FIG. 3.

In one embodiment, the outer section 208 of the blade may be made using an elastomeric or fiber material. The inner section 206 of the blade 204 may be made using a stiff material. The blade 204 may be over-molded. A resin may be used during the over-molding process and fibers on the leading edge may be left to dry without any resin during the layup, in order to create an effective interface for the over-mold. The resin layer creates a protective layer over the blade 204 and helps integrate the inner section 206 and outer section 208 of the blade 204 as a single unit. The over-molding process may also increase the strength and rigidity of the blade 204. The outer section 208 with the leading edge may be left dry. The over-molding protects the blade 204 from shocks, vibrations, abrasions and helps to integrate the inner section 206 and the outer section 208. During an impact, the leading edge made of the elastomeric or fiber material may help to reduce the impact energy transfer to the rest of the blade 204, and help reduce any damage to the blade 204 and the UAV 102.

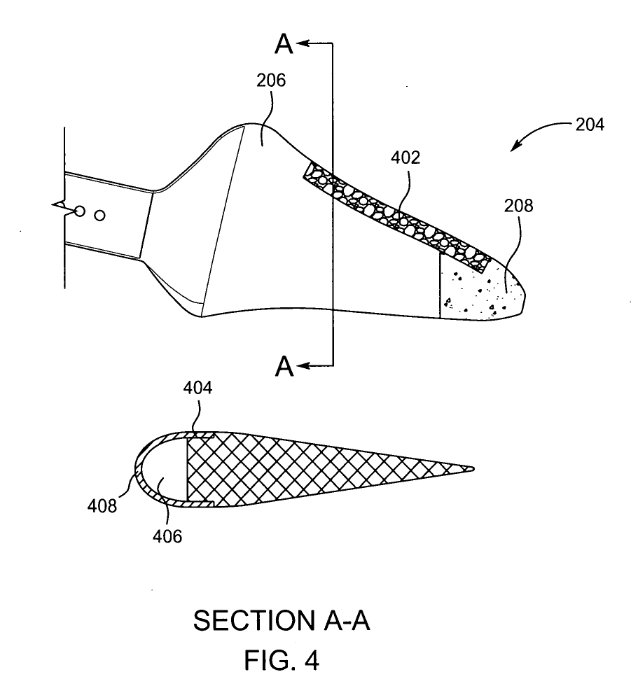

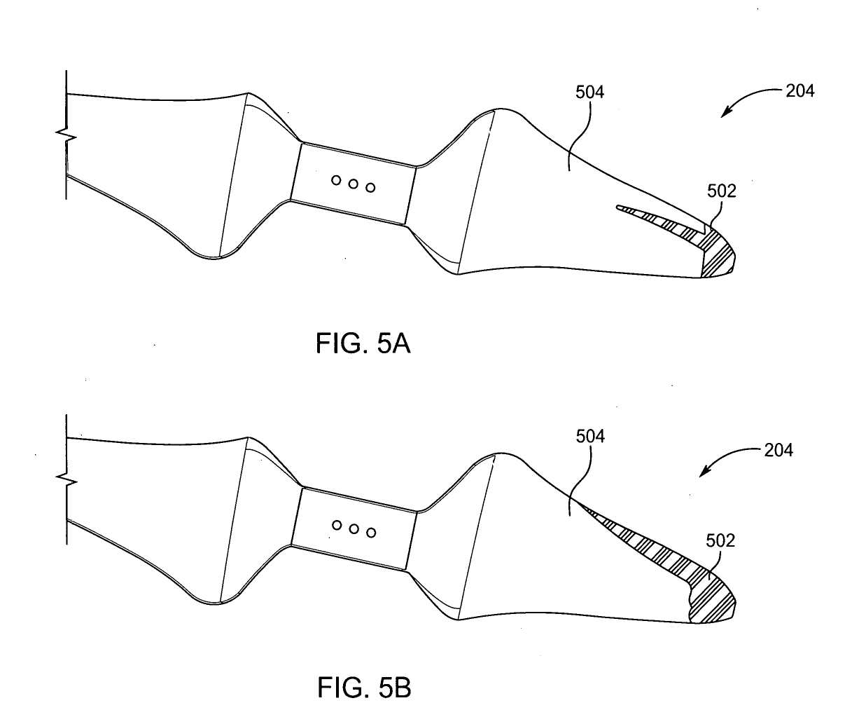

In one embodiment, a leading edge 402 of the blade 204 may be made hollow. Further, the leading edge 402 of the blade 204 may be made of foam or an elastomeric material. Such design of the blade 204 may lower overall weight of the blade 204, and resulting in the least damage to the blade 204, during an impact. FIG. 4 illustrates a cross sectional view of the blade across sections A-A. The leading edge 402 may be coupled together using mechanical joints, such as lap joint, butt joint, pinned joint, and sockets, such as plastic outer socket and foam inside socket. Further adhesion techniques, such as double-sided tape, adhesive, and press fit, barb, snap fit, and over molded design may be used. FIG. 4a illustrates a transfer adhesive lap joint 404 of the leading edge 402 and the rest of the blade. The leading edge 402 of the blade 204 may be constructed in a shell manner having an air gap 406. The air gap 406 may help in weight reduction of the blade. The rest of the blade may be constructed using a stiff material. The blade may be over-molded by a thermoformed or compression molded plastic and form a layer 408 over the leading edge and the blade, as illustrated in FIG. 4. In an embodiment, the leading edge 502 of the blade 204 may be made of the elastomeric material and rest of the blade 204 may be made of a stiff polymer, as illustrated in FIG. 5a and FIG. 5b. The elastomeric material on the leading edge 502 decreases the transferred impact energy through deformation during impact as well as decreases the specific impact energy (energy per unit area) by increasing the impact area as it deforms. Apart from the leading edge 502 of the blade 204, a portion of the blade 204 behind the leading edge may also be made of the elastomeric material, as specifically illustrated in FIG. 5b. With such an arrangement, a larger portion of the elastomeric material of the blade 204 may absorb the impact's energy, leading to the least damage of the blade 204. The elastomeric material may help to protect the propeller from damage due to impact.

In one embodiment, a lead-lag hinge may be used on the blade 204. A lead lag hinge allows the blade 204 to pivot forward and backward. Further, the lead-lag hinge may reduce kinetic energy transferred to a subject on impact of the propeller of the UAV 102.

In one embodiment, a notch may be constructed on the leading edge 402 of the blade 204. A notch may allow the blade 204 to reduce the breakaway force. The leading edge 402 may break away from the notch due to impact. The breaking away of the leading edge 402 may reduce the forces transmitted to the subject on impact. Further, the lead-lag hinge may reduce kinetic energy transferred to a subject on impact of the propeller of the UAV 102.

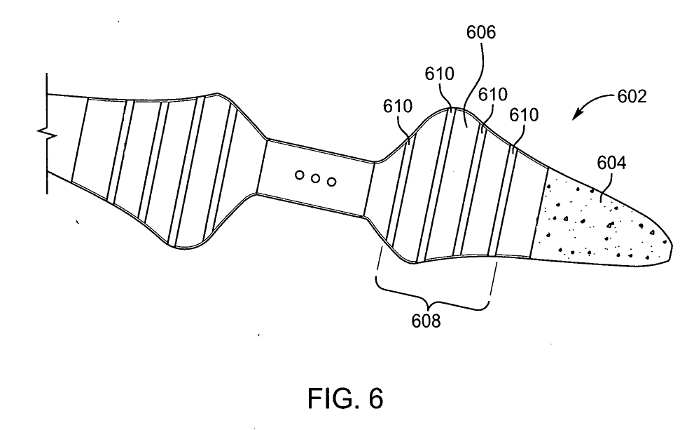

In one embodiment, the outer section 604 of the blade 602 may be made of a non-solid material including foam or resin with hollow microspheres and the inner section 606 may comprise a skeleton structure 608 made of plastic, as illustrated in FIG. 6. The foam on the outer section 604 may extend into the inner section 606. The skeleton structure 608 may comprise ribs 610 in between the foam for providing increased strength. The ribs 610 in skeleton structure 608 can be offset to allow plastic to flex as root of foam prop gets pressed inside the skeleton structure 608. The ribs may be made of plastic, lightweight metals like aluminum, magnesium and the like.

In one case, during an impact, the sensors may detect movement of the arm 106 beyond a pre-defined threshold. A signal may be sent to a control system of the electrical circuitry by the sensors. The control system, driven by a microcontroller, may disconnect electrical supply to all motors present in the propeller 108. In another case, the control system may temporarily stop the motor of the propeller 108 which participated in the impact. This may allow in recovering the flight of the UAV upon recovery of the arm 106 to its original position, thus saving the UAV from crash. The sensors may include magnetometers, contact sensors, electrical contact based sensors, and the like. Stopping of the propellers 108 may help in avoiding any damage caused by the propellers striking the main body 104.

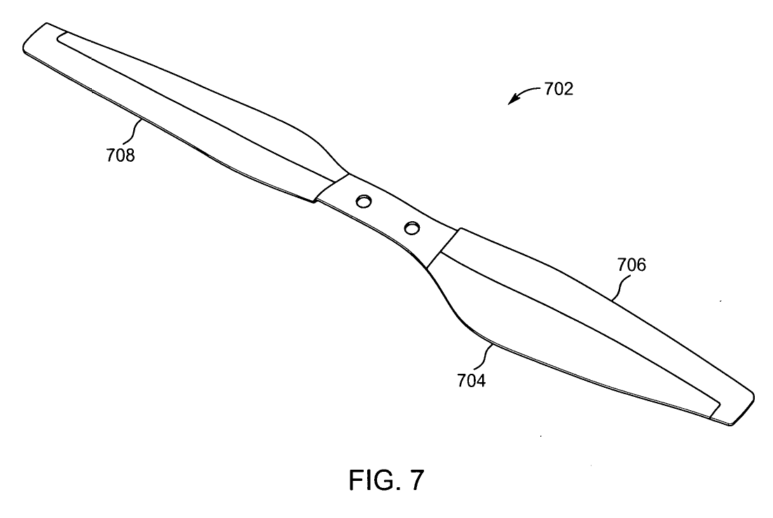

Referring to FIG. 7, a co-molded carbon fiber propeller 702 is illustrated and explained. FIG. 7 illustrates the propeller 702 fabricated out of woven sheet carbon fiber with a co-molded leading edge comprised of a main body 704. The main body 704 may be fabricated out of woven carbon fiber sheet. The propeller 702 may further comprise a co-molded elastomer leading edge 706 and a co-molded elastomer edge portion 708. The co-molded elastomer edge portion 708 may include an air-foil shaped cross-section. Such design of the propeller 702 provides the benefits of protecting users from injury by a rotating blade, and improved thrust efficiency.

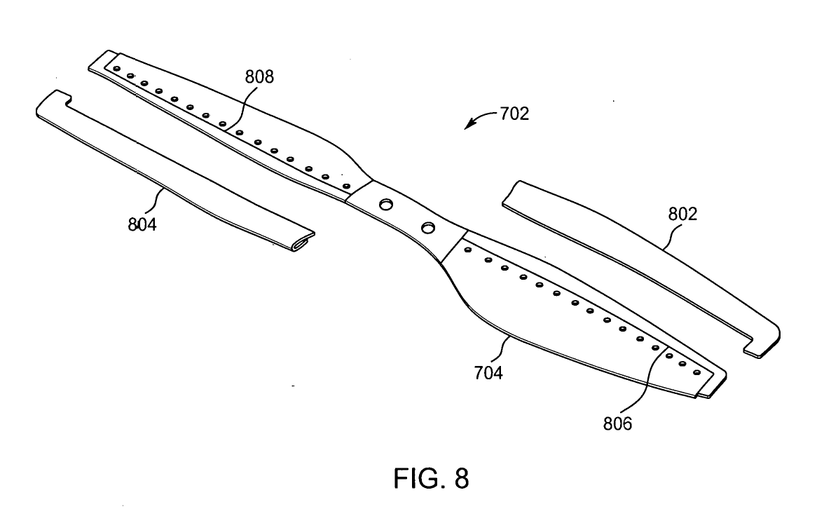

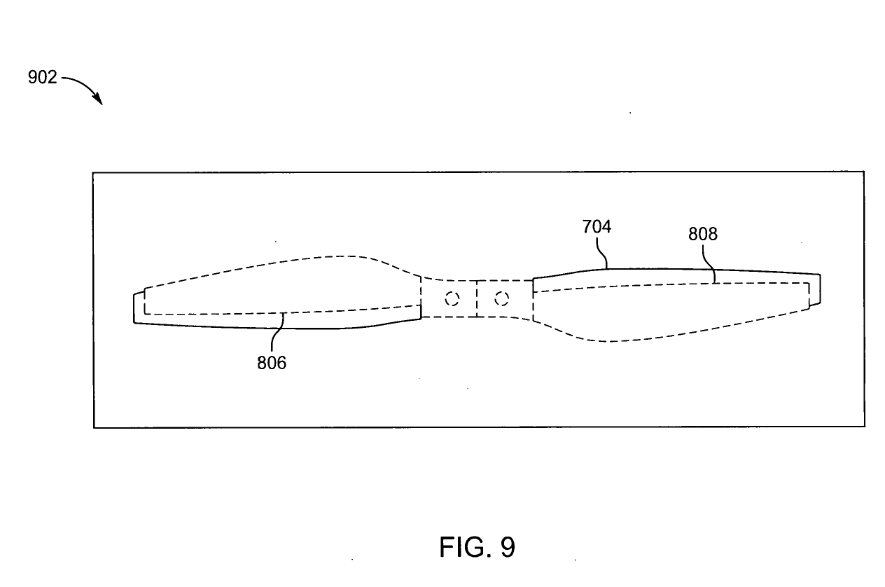

FIG. 8 illustrates an exploded view of the carbon fiber propeller 700, according to an embodiment. The carbon fiber propeller 700 comprises the main body 704, an elastomer over-mold A 802 and an elastomer over-mold B 804. The main body 704 further comprises a raw carbon fiber area 806 and a raw carbon fiber area 808. For the carbon fiber propeller 700, the main body 704 may be initially a die cut piece of woven carbon fiber sheet placed into a two-part mold 902. In a two-part mold 902, illustrated in FIG. 9, the main body 704 may be formed into a three-dimensional shape with each blade of the carbon fiber propeller 700 formed to have an angle of attack.

FIG. 9 illustrates a simplified top view of the two-part mold 902 for fabricating the carbon fiber propeller 702. Curable epoxy (not shown) may be injected into areas enclosed by the dashed lines which designate where the mold shuts off against the main body 704 sheet. The epoxy binder may infiltrate the interstices in carbon fiber cloth. The raw carbon fiber area 806 and the raw carbon fiber area 808 of the main body 704 sheet outside of the shut-off areas may remain un-infiltrated with the epoxy. When the epoxy hardens, the main body 704 may become a rigid composite material. The details of the process of filling woven sheet with epoxy is well-known to those skilled in the art of composite fabrication.

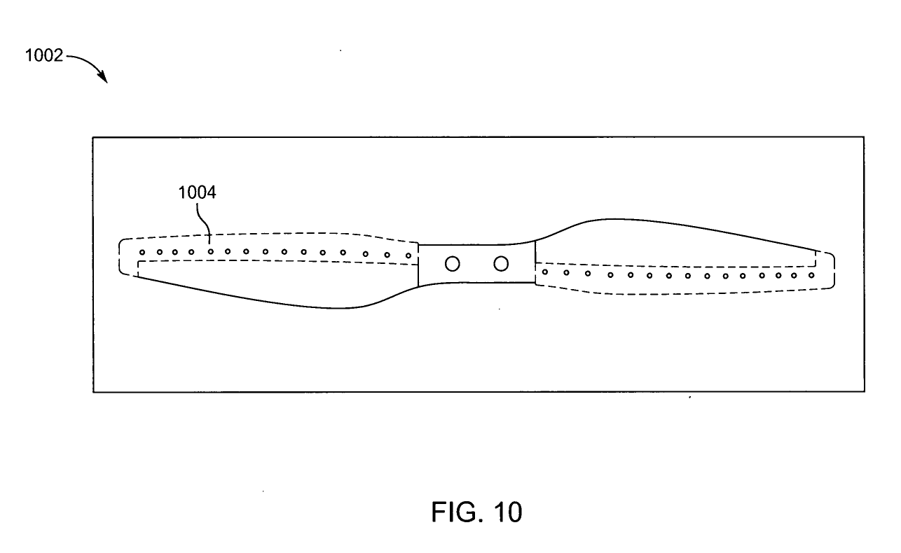

FIG. 10 illustrates a simplified top view of a two-part mold 1002 for co-molding a leading edge with an air foil cross-section onto the carbon fiber propeller 702. Curable two-part elastomer material may be injected into the areas enclosed by the dashed lines which designate where the mold shuts off against the main body 704. Elastomer material may infiltrate the interstices in the raw carbon fiber area 806 and the raw carbon fiber area 808, forming a substantially resilient attachment to the main body 704. Through holes 1004 may be drilled after the main body 704 filled with hardened epoxy is removed from the two-part mold 902. The elastomer may also fill the through holes 1004 so that the portion of the leading edge 802 and the leading edge 804 on the top and bottom of the main body 704 are connected, providing further fastening of the leading edge 802 and the leading edge 804 to the main body 704.

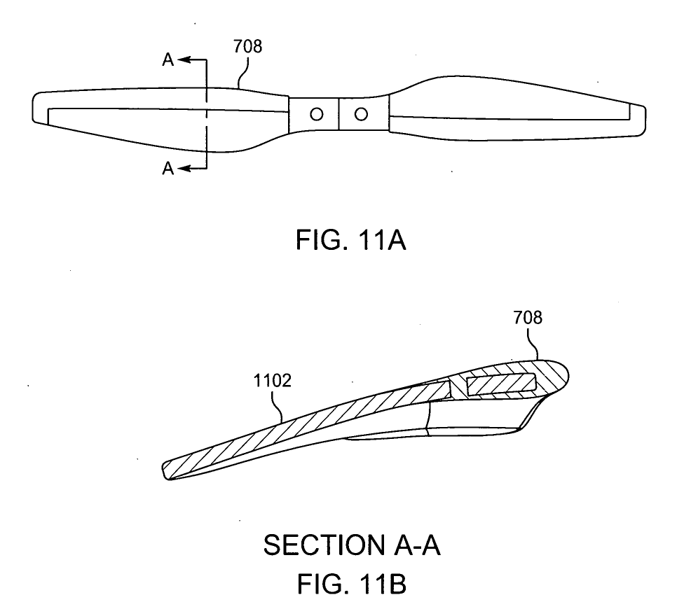

FIGS. 11a and 11b illustrate a cross-section view of the carbon fiber propeller 702 with an elastomeric co-molded leading edge having an air-foil shape. FIGS. 11a and 11b also illustrates an enlarged cross-section view of the carbon fiber propeller 702 that shows the formed carbon fiber sheet composite component 1102 and the co-molded elastomer edge portion 708, which provides an air foil cross-section profile. The cross-section detail in FIG. 11b also shows the through hole 1004 filled with the elastomeric material that is a part of the co-molded elastomer edge portion 708.

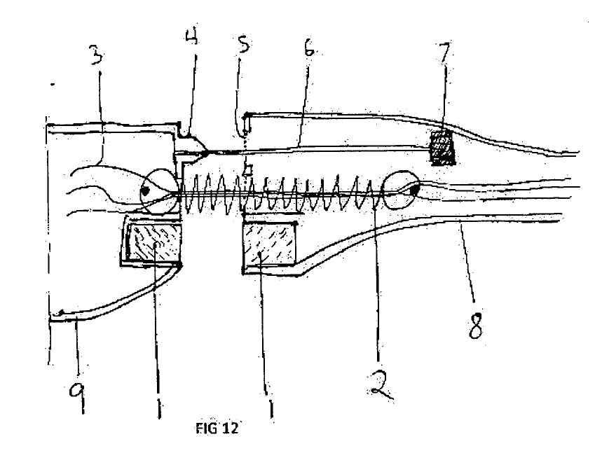

FIG. 12 illustrates a tapered torsion resisting feature and semi-flexible rod to maintain orientation of the arm. A pair of magnets 1 may be present on opposite ends of arms of the propeller. Further, a spring 2 may connect the opposite ends of the arms through which motor wires 3 may reach to the electrical circuitry of the UAV. In one embodiment, one or more tapered protrusion 4 may stick out of one side of the hub 9 and into the other, such that the tapered protrusion 4 fits into a similarly sized orifice 5 present on an opposing side i.e. arm 8. The tapered protrusion 4 may help oppose torsional forces created by a propeller on the arm 8 in flight. Additionally, one or more semi-flexible rods 6 may extend from one side of the joint to the orifice 5 present on the other side of the joint. Such one or more semi-flexible rods 6 may be used to maintain rotational orientation of the arm as it reconnects with a hub 9. In one possible embodiment, 0.020″ super-elastic nitinol wire was used for the semi-flexible rod 6. Such semi-flexible rods 6 may also be used to provide torsional stiffness, by interacting with the orifice 5 present in the opposing side of the joint when connected. Further, a stopper 7 may be used to prevent over travel of the semi-flexible rod 6.

The present disclosure, in various embodiments, configurations and aspects, includes components, methods, processes, systems and/or apparatus substantially developed as depicted and described herein, including various embodiments, sub-combinations, and subsets thereof. Those of skill in the art will understand how to make and use the present disclosure after understanding the present disclosure. The present disclosure, in various embodiments, configurations and aspects, includes providing devices and processes in the absence of items not depicted and/or described herein or in various embodiments, configurations, or aspects hereof, including in the absence of such items as may have been used in previous devices or processes, e.g., for improving performance, achieving ease and/or reducing cost of implementation.

In this specification and the claims that follow, reference will be made to a number of terms that have the following meanings. The terms “a” (or “an”) and “the” refer to one or more of that entity, thereby including plural referents unless the context clearly dictates otherwise. As such, the terms “a” (or “an”), “one or more” and “at least one” can be used interchangeably herein. Furthermore, references to “one embodiment”, “some embodiments”, “an embodiment” and the like are not intended to be interpreted as excluding the existence of additional embodiments that also incorporate the recited features. Approximating language, as used herein throughout the specification and claims, may be applied to modify any quantitative representation that could permissibly vary without resulting in a change in the basic function to which it is related. Accordingly, a value modified by a term such as “about” is not to be limited to the precise value specified. In some instances, the approximating language may correspond to the precision of an instrument for measuring the value. Terms such as “first,” “second,” “inner,” “outer” etc. are used to identify one element from another, and unless otherwise specified are not meant to refer to a particular order or number of elements.

As used herein, the terms “may” and “may be” indicate a possibility of an occurrence within a set of circumstances; a possession of a specified property, characteristic or function; and/or qualify another verb by expressing one or more of an ability, capability, or possibility associated with the qualified verb. Accordingly, usage of “may” and “may be” indicates that a modified term is apparently appropriate, capable, or suitable for an indicated capacity, function, or usage, while taking into account that in some circumstances the modified term may sometimes not be appropriate, capable, or suitable. For example, in some circumstances an event or capacity can be expected, while in other circumstances the event or capacity cannot occur—this distinction is captured by the terms “may” and “may be.”

As used in the claims, the word “comprises” and its grammatical variants logically also subtend and include phrases of varying and differing extent such as for example, but not limited thereto, “consisting essentially of” and “consisting of.” Where necessary, ranges have been supplied, and those ranges are inclusive of all sub-ranges therebetween. It is to be expected that variations in these ranges will suggest themselves to a practitioner having ordinary skill in the art and, where not already dedicated to the public, the appended claims should cover those variations.

The foregoing discussion of the present disclosure has been presented for purposes of illustration and description. The foregoing is not intended to limit the present disclosure to the form or forms disclosed herein. In the foregoing Detailed Description for example, various features of the present disclosure are grouped together in one or more embodiments, configurations, or aspects for the purpose of streamlining the disclosure. The features of the embodiments, configurations, or aspects of the present disclosure may be combined in alternate embodiments, configurations, or aspects other than those discussed above. This method of disclosure is not to be interpreted as reflecting an intention that the present disclosure requires more features than are expressly recited in each claim. Rather, as the following claims reflect, the claimed features lie in less than all features of a single foregoing disclosed embodiment, configuration, or aspect. Thus, the following claims are hereby incorporated into this Detailed Description, with each claim standing on its own as a separate embodiment of the present disclosure.

Advances in science and technology may make equivalents and substitutions possible that are not now contemplated by reason of the imprecision of language; these variations should be covered by the appended claims. This written description uses examples to disclose the method, machine and computer-readable medium, including the best mode, and also to enable any person of ordinary skill in the art to practice these, including making and using any devices or systems and performing any incorporated methods. The patentable scope thereof is defined by the claims, and may include other examples that occur to those of ordinary skill in the art. Such other examples are intended to be within the scope of the claims if they have structural elements that do not differ from the literal language of the claims, or if they include equivalent structural elements with insubstantial differences from the literal language of the claims.

What is claimed is:

1. A foldable Unmanned Aerial Vehicle (UAV) comprising:
a main body comprising at least electrical circuitry, a battery, and at least one electrical sensor;
a plurality of arms connected to the body; and
a propeller connected to each arm of the plurality of arms,
wherein each arm is connected to the main body using an impact protection mechanism for allowing an omni-directional movement of each arm.

2. The foldable UAV of claim 1, wherein the main body comprises sensors selected from a group consisting of magnetometer, accelerometer, gyroscope, Global Positioning System (GPS), sonar, contact sensor, and electrical contact based sensor.

3. The foldable UAV of claim 2, wherein at least one of the sensors detect folding of the at least one arm beyond a pre-defined threshold and stops at least one motor in response.

4. The foldable UAV of claim 1, wherein the impact protection mechanism comprises at least one of magnets, springs, or mechanical joints.

5. The foldable UAV of claim 1, wherein the impact protection mechanism utilizes a pair of magnets, and wherein a first magnet is present on an arm and a second magnet is present on a hub connected to the main body.

6. The foldable UAV of claim 1, wherein the impact protection mechanism utilizes a spring connected inside of an arm and extending to the main body.

7. The foldable UAV of claim 1, wherein the impact protection mechanism utilizes a mechanical joint for connecting the plurality of arms with the main body.

8. The foldable UAV of claim 1, further comprising an enclosure holding the plurality of arms in a folded position.

9. The foldable UAV of claim 1, further comprising an extension limiter connected between the plurality of arms and the main body for limiting movement of the plurality of arms.

10. The foldable UAV of claim 1, wherein the propeller comprises at least one blade, and wherein an inner section of the at least one blade is made of a first material and an outer section of the at least one blade is made of a second material.

11. The foldable UAV of claim 10, wherein the inner section and the outer section are adjoined using one of adhesives, overmolding, barbed structures, or press fits.

12. The foldable UAV of claim 10, wherein the first material is selected form a group consisting of plastic, carbon composite, wood, and metals.

13. The foldable UAV of claim 10, wherein the second material is selected form a group consisting of expanded polystyrene foam, extruded expanded polypropylene foam, expanded polypropylene foam, foamed plastics, low-density woods, balsa wood, resin mixed with hollow microspheres, and elastomeric materials.

14. The foldable UAV of claim 10, wherein the second material is covered with layers made of skinned foam or a tape embedded with a stiff tensile element.

15. The foldable UAV of claim 14, wherein the stiff tensile element is selected from a group consisting of fiberglass, carbon, vacuum formed plastic, blow molded covering, and resin covering.

16. The foldable UAV of claim 10, wherein a leading edge of the at least one blade is hollow.

17. The foldable UAV of claim 16, wherein the leading edge is constructed in a shell manner to leave an air gap in the at least one blade.

18. The foldable UAV of claim 16, wherein the leading edge is coupled to the at least one blade using one of a lap joint, butt joint, pinned joint, plastic outer socket, foam inside socket, double-sided tape, adhesive, press fit, barb fit, snap fit, and an over molded design.

19. The foldable UAV of claim 16, further comprising a notch present on the leading edge, wherein the leading edge breaks away from the notch during an impact.

20. The foldable UAV of claim 10, wherein the inner section has a skeleton structure comprising ribs.
